(19) United States
(12) Patent Application Publication
(10) Pub. No.: US 2002/0169253 A1
(43) Pub. Date: Nov. 14, 2002

(54) Primer for plastic films

(76) Inventor: Dennis Emmett McGee, Penfield, NY (US)

Correspondence Address: ExxonMobil Chemical Company, P.O. Box 2149, Baytown, TX, 77522, US

(21) Appl. No.: 09/877,582

(22) Filed: Jun. 8, 2001

Related U.S. Application Data
(62) Division of application No. 09/367,209, filed on Aug. 10, 1999.
(60) Provisional application No. 60/037,585, filed on Feb. 10, 1997.

(51) Int. Cl. C08G 63/48

(52) U.S. Cl. 525/58

(57) ABSTRACT

The invention relates to a primer for plastic films which comprises a blend of poly(vinyl alcohol) and an adhesion promoter, specifically poly(ethylene imine) and a hardened epoxy resin. The invention is useful to improve the oxygen barrier properties of a plastic film.

### RELATED APPLICATIONS

This application is a divisional of co-pending U.S. application Ser. No. 09/367,209 filed on Aug. 10, 1999. Co-pending U.S. application Ser. No. 09/367,209 is incorporated herein by reference in its entirety.

### FIELD OF THE INVENTION

The invention relates to a primer for plastic films which comprises a blend of poly(vinyl alcohol) and an adhesion promoter, specifically poly(ethylene imine) and a hardened epoxy resin. The invention provides plastic films with excellent oxygen-barrier properties.

### BACKGROUND OF THE INVENTION

Oriented plastic film, specifically poly(vinyl alcohol), has been widely used for packaging products, particularly foods. Poly(vinyl alcohol) is a water-soluble synthetic polymer made by alcoholysis of polyvinyl acetate. Among other things, it is known for utility as a laminating adhesive. When used in packaging films, poly(vinyl alcohol) has been described as providing a film which is impervious to oils, fats and waxes and to be an excellent oxygen barrier. For this reason, poly(vinyl alcohol) is often used as barrier coatings on thermoplastic films. No single unmodified polymeric film, however, has the gas and moisture barrier characteristics and adhesion property needed for packaging.

Attempts have been made in the past to provide polymeric films which have high oxygen, oil, and moisture barrier. Furthermore, some polymeric film can have a metal layer firmly bonded thereto. In U.S. Pat. No. 5,330,831 to Knoerzer et al., a multilayer film was disclosed. The multilayer film of Knoerzer et al. includes a polymeric substrate having a primer coating on at least one surface of the substrate, a layer of cross-linked poly(vinyl alcohol) on the coating, and a layer of a blend of a poly(vinyl alcohol) homopolymer or copolymer and an ethylene acrylic acid copolymer on the cross-linked layer. This reference also discloses that an optional metal layer can be deposited on the blend layer. In addition, U.S. Pat. No. 4,214,039 to Steiner et al. is directed to thermoplastic films which include a film substrate having a primer coating layer applied to it, and a vinylidene chloride polymer as a top coat applied on the primer coating layer. These films, however, require two separate layers of primer and polymer in order to obtain both chemical barrier and adhesion properties. Many coaters only have two stations for applying coating to one side of a film at a time.

Accordingly, there is a need in the art of packaging materials to provide a precoating layer that has excellent oxygen barrier and adhesion to plastic films.

It is, therefore, an object of the present invention to provide a primer layer with excellent oxygen barrier for packaging materials. By combining barrier and adhesion properties into a single layer, this frees a coating station that can be used to apply addition barrier and/or other properties such as sealability.

### SUMMARY OF THE INVENTION

The present invention relates to a primer for plastic films and the use of the primer in packaging materials. The primer includes a blend of poly(vinyl alcohol) and an adhesion promoter, specifically poly(ethylene imine) and/or a hardened epoxy resin. The invention is useful to improve the oxygen-barrier properties of a plastic film.

The hardened epoxy resin is in an amount of about 15 to about 35 parts per hundred polyvinyl alcohol). The primer can further include an glyoxal in an amount of about 10 to about 20 parts per hundred poly(vinyl alcohol). In addition, the primer can further include choline chloride. The adhesion promoter is preferably polyethyleneimine.

The packaging material of the present invention includes (a) a packaging substrate that has a first surface layer and a second surface layer; (b) a precoating layer having a primer coated on at least one surface layer of the substrate, wherein the primer is a blend of poly(vinyl alcohol), an adhesion promoter and an epoxy resin; and (c) optionally a top coat layer and/or a metallic layer deposited thereon the precoating layer.

Advantageously, as the result of the present invention, packaging films having a unique primer layer are produced. The unique blend of the primer layer of the present invention provides excellent oxygen barrier properties.

The primer layers of the present invention can have a coating layer and/or a metallic layer deposited thereon, and thus offer greater barrier properties and sealant strength. For example, an unexpected synergy between the primer and top coats provides additional barrier enhancement.

For a better understanding of the present invention, together with other and further objects, reference is made to the following description and figures, and its scope will be pointed out in the appended claims.

### DESCRIPTION OF THE DRAWINGS

FIG. 1 is a plot showing the concentration of primer ingredients vs. oxygen barrier properties of the uncoated film;

FIG. 2 is a plot showing the concentration of primer ingredients vs. oxygen barrier properties for the coated films;

FIG. 3 is a plot showing the concentration of primer ingredients vs. oxygen barrier properties for the metallized film;

FIG. 4 is a plot showing the concentration of primer ingredients vs. crimp-seal strength for coated films for seals formed at 127° C.; and

FIG. 5 is another plot showing the concentration of primer ingredients vs. crimp-seal strength for coated films for seals formed at about 104° C.

### DESCRIPTION OF THE INVENTION

The invention comprises a primer for plastic film and the use of the primer in packaging materials. The primer is a blend of poly(vinyl alcohol) and an adhesion promoter and a hardened epoxy resin.

The primer of the invention can be used as a primer layer for coatings and/or metallization of a substrate such as oriented polypropylene or other plastic film. The primed and coated or primed and metallized film has enhanced oxygen barrier properties. Synergistic oxygen barrier properties have been found in that the barrier properties are better than expected based on the oxygen barrier contribution of the individual layers.

The poly(vinyl alcohol) in the blend of the present invention refers to any commercially available poly(vinyl alcohol), e.g., EVANOL 71-30, an E.I. DuPont product.

Examples of the adhesion promoter include, but are not limited to, hardened epoxy as described by U.S. Pat. No. 4,214,039 to Steiner which is incorporated herein by referenced and polyethyleneimine, in which polyethyleneimine is preferred.

The amount of the epoxy resin can range from between about 15 and about 35 parts per hundred parts poly(vinyl alcohol). Higher epoxy levels are found to degrade barrier properties, 25 parts per hundred parts poly(vinyl alcohol) result in good oxygen barrier properties.

The primer coating can further contain a cross-linking agent in an amount ranging from about 10 and 20 parts per hundred parts poly(vinyl alcohol). A higher level is useful to promote cross-linking of the PVOH primer. Suitable examples of the cross-linking agent in the present invention include, but are not limited to, glyoxal, melamine formaldehyde, glutaraldehyde, with glyoxal being preferred.

It is contemplated that sealable coatings such as acrylic coatings and low temperature sealable coatings will adhere well to the primer of this invention.

The coating weight of the primer of this invention is most easily controlled by the solids level. It is preferred to apply the primer at about 6% solids, which with our application method provides a primer coat weight of about 0.4 g/1000 square inches (g/msi). Lower levels favor adhesion to other coatings but must be balanced with barrier properties. Higher solids levels can adversely impact operability because the primer becomes too viscous.

The coating weights of coatings applied to the primer of this invention are typical to those used in the film coating industry. Examples in this disclosure range between about 0.6% to about 1.3% solids which provides about 0.6 to about 1.3 g/msi, coating weight, depending upon the coating applied. However, this range should not be construe as limiting.

Choline chloride can also be added to the primer formulation in amounts of about 0.25 parts per hundred poly(vinyl alcohol).

Evaluation of static levels indicates that with the primer of this invention, acrylic-based coatings exhibit an acceptably low tendency to develop a static charge.

The packaging material of the present invention includes (a) a packaging substrate that has a first surface layer and a second surface layer; (b) a precoating layer having a primer coated on at least one surface layers of the substrate, wherein the primer is a blend of poly(vinyl alcohol), an adhesion promoter and an epoxy resin; and (c) optionally a top coat layer and/or a metallic layer deposited thereon the precoating layer. The blend in the primer can further include a cross-linking agent and/or choline chloride.

The packaging substrate of the present invention includes any polymeric film substrate which inherently permits the transmission of oxygen and water vapor, and wherein the utility of such film for packaging purposes would call for a minimization of such transmission. Suitable examples of the polymeric materials include, but are not limited to, nylon, polyethylene teraphthaplate, polycarbonate, and polyolefins. Preferably, the substrate is a polyolefin including, but not limited to polyethylene, polypropylene, polybut ylene, terpolymers, copolymers, and blends thereof. More preferably, the substrate is an oriented polypropylene.

Examples of the packaging substrate of the present invention can also include paperboards and fiberboard. Suitable examples of the paperboards and fiberboards can include, but are not limited to, glassine papers and clay coated papers.

The packaging substrate of the present invention can be of any desired thickness. Generally, to ensure good machinability on high speed packaging equipment, the thickness of the substrate is from about 10 to about 50 microns, preferably, from about 10 to about 35 microns, and more preferably from about 12 to about 25 microns.

At least one surface of the packaging substrate of the present invention is coated with a precoating layer by any coating method known in the art, e.g., gravure coating. The polymeric substrate can be pretreated to enhance the adhesion of the precoating layer to the polymeric substrate by any pretreatment known in the art. Pretreatments well known in the art include, but are not limited to, flame treatment, plasma treatment, chemical treatment and corona discharge treatment that are well known in the art. Flame treatment and corona discharge treatment are preferred with corona discharge treatment being particularly more preferred.

As previously described, the primer coating of the present invention is a blend of poly(vinyl alcohol), an adhesion promoter and an epoxy resin. The blend in the primer coating can further include a cross-linking agent and/or choline chloride.

The thickness of the precoating layer is from about 0.5 to about 2.0 microns, preferably, from about 0.7 to about 1.5 microns, and more preferably from about 1.0 to about 1.5 microns.

The weight ratio of the adhesion promoter and epoxy resin and polyvinyl alcohol is from about 0.15 to about 0.35, preferably from about 0.20 to about 0.30, and more preferably from about 0.22 to about 0.28.

The weight ratio of the cross-linking agent and polyvinyl alcohol is from about 0.05 to about 0.4, preferably from about 0.10 to about 0.30, and more preferably from about 0.11 to about 0.12.

The precoating layer of the present invention can optionally have a top coat layer and/or a metallic layer deposited thereon. The top coat layer can be applied on top of the precoating layer by any manner known in the art, e.g., gravure coating. The function of the top coat layer is to provide additional barriers and/or sealability and/or machinability and/or printability.

Examples of coating materials to be used as a top coat layer are described in U.S. Pat. No. 4,214,039 to Steiner which is incorporated herein by reference. Preferred examples of the coating materials include, but are not limited to, emulsions or solutions comprising poly(vinylidene) chloride, poly(vinyl chloride), poly(vinyl alcohol), ethylene acrylic acid copolymer, and acrylic. The thickness of the coating layer is up to 5.0 microns.

The metal layer is deposited on the top layer by a manner known in the art, e.g., vacuum metallization or plasma deposition. The metal layer provides the packaging material with extra barrier and sealant properties.

Suitable examples of metals for the metal layer can include, but are not limited to, aluminum and aluminum oxide.

### EXAMPLES

The following non-limiting examples illustrate the chemical barrier and adhesive properties of the films of the conventional packaging films and the packaging films of present invention.

### EXAMPLE 1

### PACKAGING FILMS OF THE PRESENT INVENTION

This example illustrates the chemical barrier and adhesion properties of the packaging films of the present invention. Chemical barrier and adhesion tests were performed on eight film substrates having various coating compounds.

Each of the eight film substrates was coated with eight different precoating layers of primer blends. The primer blends were applied utilizing a reverse direct gravure coating. The coated films were passed through a dry-air oven at about 125 ft/min. and at a temperature of 200° F. The primer blends include PVOH, epoxy primer, and glyoxal. The primer blends are illustrated in Table 1.

TABLE 1

| Sam- | | | | | |
|---|---|---|---|---|---|
| ple | | | Epoxy | | |
| No. | Roll No. | PVOH | at 12% solids | Glyoxal | Coat wt. |
| 1 | PC-06186-01 | 100 phr | 15 phr | 10 phr | 0.2 g/msi |
| 2 | PC-06186-02 | 100 phr | 25 phr | 10 phr | 0.2 g/msi |
| | (0.25 phr Choline | | | | |
| | Chloride was also | | | | |
| | included) | | | | |
| 3 | PC-06186-03 | 100 phr | 15 phr | 15 phr | 0.2 g/msi |
| 4, | PC-06186-04 | 100 phr | 25 phr | 15 phr | 0.2 g/msi |
| 5 | PC-06186-0 | 100 phr | 15 phr | 10 phr | 0.4 g/msi |
| 6 | PC-06186-06 | 100 phr | 25 phr | 10 phr | 0.4 g/msi |
| 7 | PC-06186-07 | 100 phr | 15 phr | 15 phr | 0.4 g/msi |
| 8 | PC-06186-08 | 100 phr | 25 phr | 15 phr | 0.4 g/msi |

Each of the eight precoating layer was then coated with a top coating layer of an EAA formulation. The EAA formulation was applied utilizing a reverse direct gravure coater. The coated films were passed through a dry air oven at a temperature of 200° F. The EAA formulation included 100 phr M4983 (Michemprime manufactured by Michelman), 1.5 phr NaOH; 4 phr carnaube wax emulsion (obtained from Michelman), 0.3 phr silloid and 0.4 phr talc.

The resulting films were tested for oxygen transmission. The dried films were then tested in an oxygen-permeability device in which a stream of dry oxygen was passed through an aqueous salt solution-permeated pad to control the gas moisture content and then through the films, disposed at right angles to the stream with the top coating layer upstream. The oxygen transmitted was determined and the amount of oxygen passed per unit area of film per time period was calculated. The results of oxygen barrier tests are shown in Table 2.

TABLE 2

| Sam- | T0₂ | Askco | Askco | Crimp | Crimp | Crimp |
|---|---|---|---|---|---|---|
| ple | (cm³/100 | 230-260 | Retained | 220 | 260 | Retained |
| No. | in²/day) | (g/in) | (g/in) | (g/in) | (g/in) | (g/in) |
| 1 | 5.02 | 169 | 166 | 100 | 140 | 145 |
| 2 | 1.64 | 186 | 163 | 125 | 200 | 255 |
| 3 | 2.41 | 134 | 129 | 105 | 150 | 170 |
| 4 | 2.12 | 144 | 171 | 150 | 160 | 180 |
| 5 | 0.33 | 373 | 168 | 160 | 190 | 190 |
| 6 | 0.15 | 515 | 541 | 265 | 220 | 360 |
| 7 | 0.20 | 261 | 230 | 260 | 220 | 215 |
| 8 | 0.16 | 421 | 411 | 400 | 415 | 310 |

From Table 2, it is observed that the packaging films of the present invention have low gas transmission and excellent adhesion property. Thus, the unique blend of the precoating layer of the present invention provides both chemical barrier and adhesion properties offer by the conventional packaging films. However, the blend of the precoating layer of the packaging films of the present invention eliminates the required primer layers of the conventional films.

### EXAMPLE 3

### METALLIZED PACKAGING FILMS

This example illustrates the chemical barrier and adhesion properties of conventional metallized packaging films and metallized packaging films of the present invention. Chemical barrier and adhesion tests were performed on nine MC550 film substrates (made by Mobil) having various coating compounds.

Each of the nine film substrates was coated with nine different precoating layers of primer blends. The primer blends include PVOH, EAA, epoxy primer, and glyoxal. The primer blends are illustrated in Table 3.

TABLE 3

| Sample | | | | | | | | | |
|---|---|---|---|---|---|---|---|---|---|
| No. | PVOH | | % Solids | EAA | | Epoxy | | Glyoxal | |
| 1 | 100 | phr | 1 | 100 | phr | 0 | phr | 0 | phr |
| 2 | 100 | phr | 1 | 200 | phr | 0 | phr | 0 | phr |
| 3 | 100 | phr. | 4 | 100 | phr | 0 | phr | 0 | phr |
| 4 | 100 | phr | 4 | 200 | phr | 0 | phr | 0 | p hr |
| 5 | 100 | phr | 1 | 0 | phr | 100 | phr | 20 | phr |
| 6 | 100 | phr | 1 | 0 | phr | 200 | phr | 20 | phr |
| 7 | 100 | phr | 4 | 0 | phr | 100 | phr | 20 | phr |
| 8 | 100 | phr | 4 | 0 | phr | 200 | phr | 20 | phr |
| 9 | 100 | phr | 4 | 0 | phr | 100 | phr | 20 | phr |

Each of the precoating layers was then metallized with a metal.

The resulting films were tested for water vapor transmission, oxygen transmission, and adhesion properties. The results of the tests are illustrated in Table 4.

TABLE 4

| Sample No. | T02 | WVTR | Scuff | Adhesion |
|---|---|---|---|---|
| 1 | 2.64 | 0.03 | Poor | Good |
| 2 | 3.09 | 0.03 | Poor | Good |
| 3 | 0.42 | 0.03 | Poor | Good |
| 4 | 1.03 | 0.02 | Poor | Good |
| 5 | 3.34 | 0.04 | Poor | Good |
| 6 | 2.01 | 0.05 | Poor | Good |
| 7 | 0.89 | 0.04 | Medium | Good |
| 8 | 1.22 | 0.04 | Medium | Good |
| 9 | 0.95 | 0.02 | Poor I | Good |

From Table 4, it is observed that Sample Nos. 5 to 9, the metallized packaging films of the present invention, have both chemical barrier and adhesion properties offer by Sample Nos. 1 to 4 of the conventional packaging films. However, the metallized packaging films of the present invention have excellent adhesion properties and thus do not require the additional primer layers of the conventional films.

### EXAMPLE 4

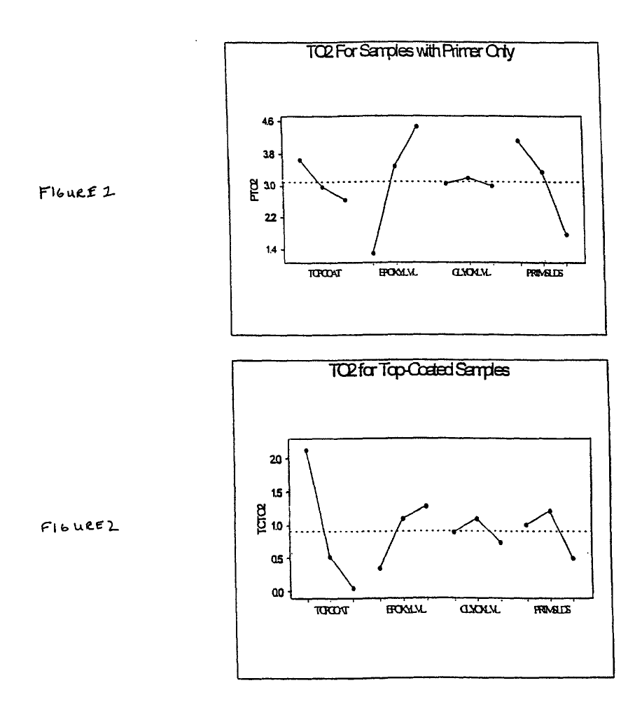

Oriented polypropylene film samples (Samples 1-21) were primed with primer formulations described in the following table. M4983 is Michemprime manufactured by Michelman. M215 is a carnaube wax emulsion obtained from Michelman. SR344 is Tospearl 145 obtained by Toshiba Silicone Co. ML71513 is a synthetic wax obtained from Michelman. D8500 is Daran 8500 obtained from Hampshire Chemical. Each of the samples were tested for oxygen barrier properties and for sealability and the results of the testing are reported in Table 5 and FIGS. 1 to 5.

TABLE 5
TABLE ACN 81
LAB COATER RUN

| BASE FILM | = | FPM | F | O | CHILL ROLL | TREATMENT LEVEL 2 |
|---|---|---|---|---|---|---|
| 92MC550 | PRIMING | 50 | 220 | 130 | 60° | |
| | TOPCOA | 50 | 220 | 130 | 60° | |

DISPERSE SYIOID 42 IN A WARING BLENDER FOR 60 SECONDS
LABEL SAMPLES AS “ACNB XX”, SUBMIT FOR PHYSICAL TESTING UNDER R#1701
SAMPLES WITH PRIMER ONLY SHOULD BE LABELLED AS “ACN8-XXA“
PREPARE STANDARD EPOXY PRIMER AND DILUTE TO 20% SOLIDS FOR USE IN BLENDS

| | | | | | | | | | | | | | | | | | | | | |
|---|---|---|---|---|---|---|---|---|---|---|---|---|---|---|---|---|---|---|---|---|
| | | | | | % | % | % | % | % | | | TOTAL | COAT | | | | | | | |
| | | | | | 10 | 20 | 40 | 1 | 1 | | | LESS | SLDS | | | | | | | |
| | | | LTX | | | STD | GLY- | SYLD | CHOL | | HEXYL | HEX | w/o | | | STD | GLY- | SYLD | CHOL | |
| ROLL | LATEX | LOT # | SLDS | LATEX | TALC | EPOXY | OXAL | 42 | Cl | H2O | CELL. | | P & H | LTX | TALC | EPOXY | OXAL | 42 | Cl | TOTAL |
| | | | % | g | g | g | g | g | u | g | u | u | % | PHR | PHR | PHR | PHR | PHR | PHR | PHR |

PART 1 PRIMING NEED ENOUGH TO MAKE SOFT.SAMPLES OF TOP COATED FILM
PLUS 10 FEET OF PRIMED FILM FOR BARRIER TESTS

| | | | | | | | | | | | | | | | | | | | | |
|---|---|---|---|---|---|---|---|---|---|---|---|---|---|---|---|---|---|---|---|---|
| ACN8 | 1 ELVANOL | 90/50 | 80 | 998 | 000 | 60 | 20 | 00 | 20 | 902 | 20 | 200 | 5 | 100 | 0 | 15 | 10 | 0 | 025 | 1253 |
| ACN8 | 2 ELVANOL | 90/50 | 80 | 1070 | 000 | 107 | 32 | 00 | 2.1 | 71.0 | 20 | 200 | 6 | 100 | 0 | 25 | 15 | 0 | 025 | 1403 |
| ACN8 | 3 ELVANOL | 90/50 | 80 | 1127 | 000 | 158 | 45 | 00 | 23 | 647 | 20 | 200 | 7 | 100 | 0 | 35 | 20 | 0 | 025 | 1553 |
| ACN8 | 4 ELVANOL | 90/50 | 80 | 1198 | 000 | 72 | 24 | 00 | 24 | 683 | 20 | 200 | 8 | 100 | 0 | 15 | 10 | 0 | 025 | 1253 |
| ACN8 | 5 ELVANOL | 90/50 | 80 | 1248 | 000 | 125 | 37 | 00 | 26 | 565 | 20 | 200 | 7 | 100 | 0 | 25 | 15 | 0 | 025 | 1403 |
| ACN8 | 6 ELVANOL | 90/50 | 80 | 805 | 000 | 113 | 32 | 00 | 16 | 1034 | 20 | 200 | 5 | 100 | 0 | 35 | 20 | 0 | 025 | 1553 |
| ACN8 | 7 ELVAHOL | 90/50 | 80 | 900 | 000 | 58 | 29 | 00 | 19 | 935 | 20 | 200 | 5 | 100 | 0 | 15 | 15 | 0 | 025 | 1303 |
| ACN8 | 8 ELVAHOL | 90/50 | 80 | 1033 | 000 | 103 | 4.1 | 00 | 2.1 | 802 | 20 | 200 | 6 | 100 | 0 | 25 | 20 | 0 | 025 | 1453 |
| ACN8 | 9 ELVANOL | 90/50 | 80 | 1205 | 000 | 169 | 24 | 00 | 2.4 | 578 | 20 | 200 | 7 | 100 | 0 | 35 | 10 | 0 | 025 | 1453 |
| ACN8 | 10 ELVANOL | 90/50 | 80 | 1294 | 000 | 78 | 52 | 00 | 26 | 65.1 | 20 | 200 | 7 | 100 | 0 | 15 20 | 0 | 025 | 1353 | |
| ACN8 | 11 ELVANOL | 90/50 | 80 | 92.4 | 000 | 92 | 18 | 00 | 18 | 946 | 20 | 200 | 5 | 100 | 0 | 25 | 10 | 0 | 025 | 1353 |
| ACH8 | 12 ELVANOL | 90/50 | 80 | 998 | 000 | 140 | 30 | 00 | 20 | 81.2 | 20 | 200 | 6 | 100 | 0 | 35 | 15 | 0 | 025 | 1503 |
| ACN8 | 13 ELVANOL | 90/50 | 80 | 1344 | 000 | 81 | 40 | 00 | 2.7 | 509 | 20 | 200 | 7 | 100 | 0 | 15 | 15 | 0 | 025 | 1303 |
| ACN8 | 14 ELVANOL | 90/50 | 80 | 861 | 000 | 86 | 34 | 00 | 1.7 | 1002 | 20 | 200 | 5 | 100 | 0 | 25 | 20 | 0 | 025 | 1453 |
| ACN8 | 15 ELVANOL | 90/50 | 80 | 1033 | 000 | 145 | 21 | 00 | 2.1 | 781 | 20 | 200 | 6 | 100 | 0 | 35 | 10 | 0 | 025 | 1453 |
| ACN8 | 16 ELVANOL | 90/50 | 80 | 1109 | 000 | 67 | 44 | 00 | 22 | 758 | 20 | 200 | 6 | 100 | 0 | 15 | 20 | 0 | 025 | 1353 |
| ACN8 | 17 ELVANOL | 90/50 | 80 | 129.4 | 000 | 129 | 28 | 00 | 26 | 525 | 20 | 200 | 7 | 100 | 0 | 25 | 10 | 0 | 025 | 135.3 |
| ACN8 | 18 ELVANOL | 90/50 | 80 | 832 | 000 | 116 | 2.5 | 0.0 | 1.7 | 1010 | 20 | 200 | 5 | 100 | 0 | 35 | 15 | 0 | 025 | 1503 |

| | |
|---|---|
| ACN8 | 19 STD PEIPRIMER (0.10% SOLIDS) TOPCOAT WITH M4983 FROM MASTER BATCH |
| ACN8 | 20 STD PEIPRIMER (0.10% SOLIDS) TOPCOAT WITH STANDARD ACRYLIC FROM MASTER BATCH |
| ACN8 | 21 STD EPOXY PRIMER (3% SOLIDS) TOPCOAT WITH DARAN 8500 FROM MASTER BATCH |

AFTER PRIMING TOP COAT ROLLS WITH COATINGS FROM THE FOLLOWING MASTER BATCHES

| | | | | | | | | | | | | | | | | | | | | |
|---|---|---|---|---|---|---|---|---|---|---|---|---|---|---|---|---|---|---|---|---|
| | | | | | | M215 | SiO2 | | | | | | | | | M215 | SiO2 | | | |
| ACN8 1-3, 10-12 | M4983 | CNTRL | 250 | 6113 | 611 | 30.6 | 0.0 | 458 | 00 | 306.2 | 00 | 1000 | 16 | 100 | 04 | 4 | 0 | 03 | 0 | 104.7 |
| | | | | | | | | SR344 | | | | | | | | | | SR344 | | |
| ACN8 4-6, 13-15 | ACRYLIC | CNTRL | 220 | 497.1 | 273 | 32.8 | 1094 | 66 | 00 | 3526 | 00 | 1000 | 16 | 100 | 025 | 6 | 40 | 0.05 | 0 | 146.3 |
| | | | | | | ML71613 | | | | | | | | | | | | | | |
| ACN8 7-9, 16-18 | D8500 | CNTRL | 490 | 641.5 | 9.43 | 23.6 | 00 | 00 | 00 | 325.5 | 00 | 1000 | 32 | 100 | 03 | 1.5 | 0 | 0 | 0 | 101.8 |

FIG. 1 is a plot showing the concentration of primer ingredients vs. oxygen barrier properties of the uncoated film. FIGS. 1 shows that high concentrations of poly(vinyl alcohol), which correspond to lower concentrations of epoxy, provide better oxygen barrier properties as does an increased coating weight.

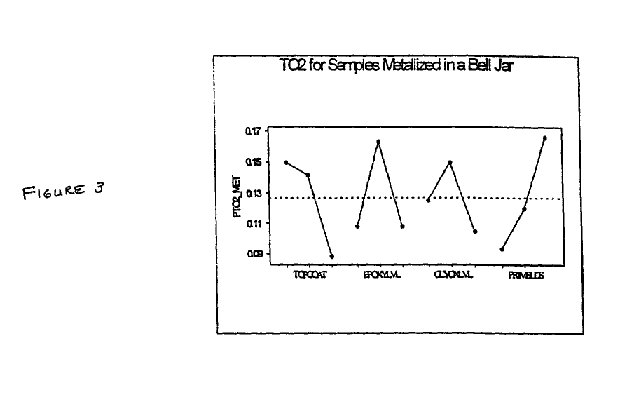

FIG. 2 is a plot showing the concentration of primer ingredients vs. oxygen barrier properties for the coated film. FIG. 2 shows that, after top coating, all samples demonstrated better oxygen barrier properties than could be expected on the basis of the barrier contribution of the individual components. For example, when coated over polyethylene imine, the low temperature sealable coating gave an oxygen barrier of 117 cm³/100 in²/day, which is approximately the barrier given by this gauge of polypropylene coated with polyethylene imine (129 cm³/100 in²/day). As shown in the graph of FIG. 1, the mean barrier for the samples that were coated with the low temperature sealable coating was about 3.7 cm³/100 in²/day. The barrier contribution of the low temperature sealable coating layer is about 1300 cm³/100 in²/day. Therefore, the expected oxygen transmission of the primed and coated film combination is expected to be no better than 3.69 cm³/100 in²/day. The expected value was calculated from the approximate barriers of the component layers:

(1/1300)+(1/3.7)=(1/3.69)

The value (1/3.7) includes the barrier of the oriented polypropylene and the primer. The value (1/300) was arrived at by subtracting the reciprocal of the barrier for polyethylene imine primed oriented polypropylene (1/117) from the reciprocal of the observed barrier of low temperature sealable coated polyethylene imine on the same gauge of oriented polypropylene (1/129).

However, the actual mean value for the six samples was about 2.1 cm³/100 in²/day. This value is lower than the mean value for any group of samples that only had the primer. It is about two-times as good as expected.

When an acrylic coating was applied to the film, the results were even better. Assuming that the oxygen transmission value for oriented polypropylene film is about 129 cm³/100 in²/day, then the barrier of the acrylic layer over polyethylene imine should contribute about 610 cm³/100 in²/day (1/107−1/129≈1/610). Therefore, it is expected that from the mean values in FIG. 1, the acrylic-coated polyethylene imine should have a barrier of 2.99 cm³/100 in²/day (⅓+1/610≈1/2.99). Yet FIG. 2 shows that the mean oxygen transmission was about six times better than expected (˜0.5 cm³/100 in²/day).

When a polyvinylidene chloride coated was applied to the primed film, at a relatively low coating weight the polyvinylidene chloride provided an oxygen barrier of about 0.85 cm³/100 in²/day on epoxy-primed film which without the coating provided an oxygen barrier of 124 cm³/100 in²/day. Therefore, the polyvinylidene chloride layer contributed 0.86 cm³/100 in²/day to the barrier. If this coating is applied to a base sheet with a barrier of 2.6 cm³/100 in²/day, then the expected oxygen barrier should be about 0.81 cm³/100 in²/day. For the six polyvinylidene chloride coated samples, the mean value was 0.05 cm³/100 in²/day. This is sixteen times better than expected.

These data show that the primer layer of the invention provides an unexpected and synergistic improvement in oxygen barrier properties when used with any top coat. Moreover, the better the inherent barrier properties of the top coat, the better the synergistic effect.

FIG. 3 is a plot showing the concentration of primer ingredients vs. oxygen barrier properties for the metallized film. Unlike the coated film samples, the metallized films show better barrier properties at low poly(vinyl alcohol) coating weights. When polyethylene imine or epoxy primed film was metallized the oxygen barrier values ranged from 1.5 to cm³/100 in²/day. Switching to the poly(vinyl alcohol) primer, the mean oxygen transmission value was about 0.13 cm³/100 in²/day. However, some samples (for example the primed film in example ACN8-16) provided an oxygen barrier value of 0.01 cm³/100 in^{2/}day after metallization. This is comparable to oriented polypropylene made with an ethylene-vinyl alcohol copolymer skin which provides an oxygen transmission range of 0.03 cm³/100 in²/day after metallization. Since films made with ethylene-vinyl alcohol copolymer skins are difficult to make, the invention provides a significant advantage.

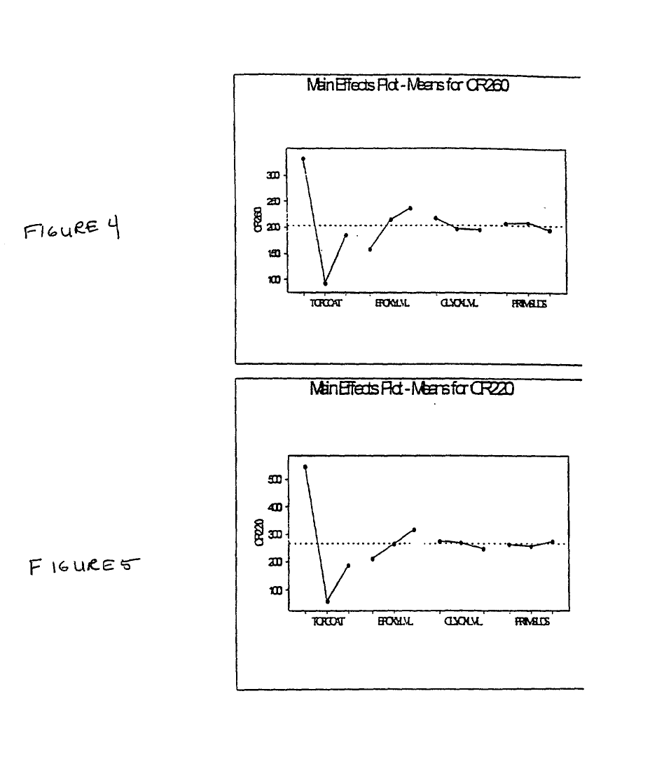

FIG. 4 is a plot showing the concentration of primer ingredients vs. crimp-seal strength for coated films for seals formed at 127° C. the best results were achieved with a low temperature sealable coating but good effects were achieved with polyvinylidene chloride (Daran 8500) which performed better than acrylic. The improvement appears to relate to adhesion to primer. Higher epoxy levels in the primer improved the adhesion to the coatings.

FIG. 5 is another plot showing the concentration of primer ingredients vs. crimp-seal strength for coated films for seals formed at about 104° C. Similar results are achieved at lower temperatures. Surprisingly the low temperature sealable coating achieved improved seals at lower temperatures. At 82° C. the low temperature sealable coating still had seals of >400 g/in.

What is claimed is:

1. A primer for plastic film comprising a blend of poly(vinyl alcohol) and an adhesion promoter and a hardened epoxy resin.

2. The primer of claim 1 in which the amount of the epoxy resin is in an amount of about 15 to about 35 parts per hundred parts poly(vinyl alcohol).

3. The primer of claim 1 which further comprising glyoxal in an amount of about 10 to about 20 parts per hundred parts poly(vinyl alcohol).

4. The primer of claim 1 which further comprises choline chloride.

5. The primer of claim 1 in which the adhesion promoter is polyethyleneimine.

6. The primer of claim 1 in which the plastic film is coated with a polymeric coating layer and/or metallized with a metallic layer, the substrate having a primer beneath the polymeric coating layer or metallic layer.

7. The primer of claim 6 in which the amount of the epoxy resin is in an amount of about 15 to about 35 parts per hundred parts poly(vinyl alcohol).

8. The primer coating of claim 6 which further comprising glyoxal in an amount of about 10 to about 20 parts per hundred parts poly(vinyl alcohol).

9. The primer of claim 6 which further comprises choline chloride

10. The primer of claim 6 in which the adhesion promoter is polyethyleneimine.
